(19) United States
(12) Patent Application Publication
(10) Pub. No.: US 2006/0282351 A1
(43) Pub. Date: Dec. 14, 2006

(54) Intellectual property account management device and intellectual property account management program

(76) Inventors: Junichi Umehara, Tokyo (JP); Takao Tazawa, Tokyo (JP); Yasuo Kotera, Tokyo (JP)

Correspondence Address: Brinks Hofer Gilson & Lione, P O Box 10395, Chicago, IL, 60610, US

(21) Appl. No.: 10/547,052

(22) PCT Filed: Feb. 24, 2004
(86) PCT No.: PCT/JP04/02101

§ 371 Date: Jul. 7, 2006

(30) Foreign Application Priority Data
Feb. 25, 2003 (JP) 2003-47141
Jul. 29, 2003 (JP) 2003-203013

(51) Int. Cl. G07B 17/00; G07F 19/00

(52) U.S. Cl. 705/30

(57) ABSTRACT

An intellectual-property accounting management device includes an acquisition price storage unit (202) for storing an acquisition price for each intellectual property, and means for updating the acquisition price in the acquisition price storage unit (202) by inputting the amount of the acquisition expense expended for acquiring a particular intellectual property to perform intellectual property accounting processing.

### TECHNICAL FIELD

The present invention relates to an intellectual-property accounting management device and an intellectual-property accounting management program, which perform accounting management of intellectual properties such as inventions, devices, designs, and so forth.

### BACKGROUND ART

As an example of conventional accounting management devices, an accounting management device has been known wherein the acquisition price of each intellectual property is input, and the depreciation of each intellectual property is calculated with the fixed installment method based on the acquisition price of each intellectual property, thereby summing up the total amount of the depreciation of all the intellectual properties (i.e., Japanese Unexamined Patent Application Publication No. 2001-125969).

However, with the above conventional accounting management device, the acquisition price of an intellectual property is taken as being unchanging regarding depreciation, but increase of the acquisition price from the point of acquisition time up to the point of completion of depreciation is not taken into consideration, such as occurs with intellectual property. For example, let us say that the point when a company receives transfer of rights of an invention from the inventor thereof and files the invention is taken as the acquisition point of the intellectual property, the acquisition price at this point is made up of “refund as to filing of the intellectual property” which is paid to the inventor by the company, and so forth. Then, at the point when the relevant invention is subjected to registration of rights as a patent, upon the company paying “refund as to registration of rights of the intellectual property” to the inventor, the acquisition price of the relevant intellectual property increases by the worth thereof. Also, in the case in which the company implements the invention, upon the company paying “refund as to implementation of the intellectual property” to the inventor, the acquisition price of the relevant intellectual property increases by the worth thereof. Also, in the case in which the company enters into licensing agreements of the patent with others, and grants the license of the relevant patent, upon the company paying “refund as to grant of license of the intellectual property rights” to the inventor, the acquisition price of the relevant intellectual property increases by the worth thereof.

Thus, the acquisition price of an intellectual property normally increases from the price at the acquisition point, resulting in a problem wherein the conventional accounting management devices cannot handle intellectual property accounting management.

The present invention has been made in light of such a situation, and the object thereof is to provide an intellectual-property accounting management device, which can handle intellectual property accounting management.

Also, another object of the present invention is to provide an intellectual-property accounting management program for realizing the intellectual-property accounting management device thereof using a computer.

### DISCLOSURE OF INVENTION

In order to solve the above problems, an intellectual-property management device according to the present invention comprises: an acquisition price storage unit for storing an acquisition price for each intellectual property; an acquisition expense input unit for inputting the amount of the acquisition expense expended for acquiring a particular intellectual property; and an intellectual-property accounting management unit for updating the acquisition price stored in the acquisition price storage unit based on the input acquisition expense, and performing intellectual property accounting processing.

According to this invention, the acquisition price of the relevant intellectual property can be updated based on the amount of the acquisition expense newly added, whereby intellectual property accounting management processing can be performed based on this acquisition price thus updated.

Also, an intellectual-property accounting management device according to the present invention further comprises an expense storage unit for storing an acquisition expense for each intellectual property for each fiscal year, and the intellectual-property accounting management unit comprises: an expense updating unit for adding the input acquisition expense to the acquisition expense of the relevant fiscal year of the relevant intellectual property stored in the expense storage unit; and an expense aggregation unit for aggregating the acquisition expense stored in the expense storage unit for each intellectual property, and storing each aggregated result in the acquisition price storage unit as the acquisition price of each relevant intellectual property.

According to this invention, the acquisition expense of each intellectual property for each fiscal year can be managed.

Also, with an intellectual-property accounting management device according to the present invention, the expense storage unit, which stores the contents of the acquisition expense for each expense item, comprises: a selected-item storage unit for storing items to be included in the acquisition price of an intellectual property, of the expense items; and a selection unit for selecting expenses to be included in the acquisition price of an intellectual property in accordance with the setting contents of the selected-item storage unit.

According to this invention, expense items to be earmarked as the acquisition price of an intellectual property can be modified by modifying the setting contents of the selected-item storage unit, thereby flexibly handling any modification, even if the types of expense items to be earmarked are modified due to modification of an accounting system.

Also, with an intellectual-property accounting management device according the present invention, the expense items include at least two or more, of a refund fee to be paid to the creator of an intellectual property, research & development expenses, an attorney's fee to be paid to an attorney to which procedures according to an intellectual property are left, and a payment fee according to an intellectual property.

Also, an intellectual-property accounting management device according the present invention further comprises: a technical-field storage unit for storing a technical field for each intellectual property; and a research & development expenses allocation unit for allocating research & development expenses to be input for each technical field to each intellectual property belonged to the relevant technical field, and reflecting these allocation results in the expense storage unit.

According to this invention, research & development expenses can be appropriately accounting-earmarked as the acquisition price of the relevant intellectual property.

Also, with an intellectual-property accounting management device according the present invention, the research & development expenses allocation unit equally divides the research & development expenses of the relevant technical field for the worth of the number of intellectual properties belonging to the same technical field.

According to this invention, the allocation amount of the research & development expenses can be easily calculated.

Also, an intellectual-property accounting management device according the present invention further comprises a weighting coefficient storage unit for storing a weighting coefficient for each intellectual property, and the research & development expenses allocation unit allocates the research & development expenses of the relevant technical field according to the ratio of the weighting coefficients possessed by the intellectual properties belonging to the same technical field.

According to this invention, the research & development expenses can be allocated according to the level of importance of intellectual property.

Also, an intellectual-property accounting management device according the present invention further comprises: a deferred-assets storage unit for storing, as deferred assets, the research & development expenses regarding an allocatable intellectual property not acquired, and the research & development expenses allocation unit starts allocation of the relevant research & development expenses, in the event that the intellectual property based on the research & development expenses which have become the deferred assets occurs.

According to this invention, the research & development expenses of which the allocation period is undetermined can be handled.

Also, with an intellectual-property accounting management device according the present invention, the intellectual-property accounting management unit comprises a fixed-assets decision unit for determining regarding whether or not the acquisition price is equal to or greater than a predetermined amount to be earmarked as fixed assets, and outputting fixed assets information.

According to this invention, an intellectual property to be served as fixed assets can be readily understood, and also can be earmarked as fixed assets in a sure manner.

Also, an intellectual-property accounting management device according the present invention further comprises a fixed-assets storage unit for storing an acquisition price for each intellectual property to be served as fixed assets, and the fixed-assets decision unit stores the acquisition price equal to or greater than the predetermined amount in the fixed-assets storage unit.

According to this invention, the fixed assets information of an intellectual property is automatically recorded.

Also, an intellectual-property accounting management device according the present invention further comprises a depreciation period storage unit for storing a depreciation period for each intellectual property, and the intellectual-property accounting management unit comprises a depreciation expense calculation unit for calculating depreciation and undepreciated balance for each intellectual property based on the acquisition price stored in the acquisition price storage unit and the depreciation period stored in the depreciation period storage unit.

According to this invention, the depreciation expense of an intellectual property from the acquisition year can be calculated with the acquisition price updated due to addition of an acquisition expense.

Also, an intellectual-property accounting management device according the present invention further comprises: a depreciation expense storage unit for storing the newest depreciation calculated for each intellectual property for each fiscal year; and a previous depreciation expense storage unit for storing the depreciation previously calculated for each intellectual property for each fiscal year, and the intellectual-property accounting management unit comprises: a depreciation expense differential amount calculation unit for calculating the differential amount between the depreciation stored in the depreciation expense storage unit and the depreciation stored in the previous depreciation expense storage unit for each fiscal year; and a depreciation expense total differential amount calculation unit for aggregating the differential amount between the depreciation expenses of all the intellectual properties for each fiscal year based on the calculated differential amount of the depreciation.

According to this invention, the total differential amount from the depreciation expense of the previous year can be readily understood for each fiscal year, thereby improving efficiency of accounting processing.

Also, an intellectual-property accounting management device according the present invention further comprises a depreciation period calculation information input unit for inputting the acquisition year and expiration year of a particular intellectual property, and the intellectual-property accounting management unit comprises a depreciation period calculation unit for calculating the depreciation period of the relevant intellectual property based on the acquisition year and expiration year which were input.

According to this invention, the depreciation period of an intellectual property can be automatically calculated based on the acquisition year and expiration year of the intellectual property.

An intellectual-property accounting management device according to the present invention comprises: an acquisition expense input unit for inputting the amount of the acquisition expense expended for acquiring a particular intellectual property; an expense storage unit for storing an acquisition expense for each intellectual property for each fiscal year; an expense updating unit for adding the input acquisition expense to the acquisition expense of the relevant fiscal year of the relevant intellectual property stored in the expense storage unit; an expiration year storage unit for storing an expiration year for each intellectual property; a book price storage unit for storing a book price for each intellectual property; a previous-year depreciation expense calculation unit for calculating a depreciation period from the previous year of a particular year based on the expiration year stored in the expiration year storage unit, and calculating the depreciation expense of the previous year based on the depreciation period and the book price of the previous year stored in the book price storage unit; and a book price updating unit for subtracting the calculated depreciation expense of the previous year from the book price of the previous year, adding the acquisition expense of the particular year stored in the expense storage unit to this subtracted result, and storing this added result in the book price storage unit as the book price of the particular year.

According to this invention, the book price of the relevant fiscal year of the relevant intellectual property can be updated based on the amount of the acquisition expense newly added. Thus, the depreciation expense from the acquisition expense additional year onwards can be calculated based on the book price updated, so the depreciation expense theretofore needs not to be updated.

Also, with an intellectual-property accounting management device according to the present invention, the expense storage unit, which stores the contents of the acquisition expense for each expense item, comprises: a selected-item storage unit for storing items to be included in the book price of an intellectual property, of the expense items; and a selection unit for selecting expenses to be included in the book price of an intellectual property in accordance with the setting contents of the selected-item storage unit.

Also, with an intellectual-property accounting management device according to the present invention, the expense items include at least two or more, of a refund fee to be paid to the creator of an intellectual property, research & development expenses, an attorney's fee to be paid to an attorney to which procedures according to an intellectual property are left, and a payment fee according to an intellectual property.

Also, an intellectual-property accounting management device according to the present invention further comprises: a technical-field storage unit for storing a technical field for each intellectual property; and a research & development expenses allocation unit for allocating research & development expenses to be input for each technical field to each intellectual property belonged to the relevant technical field, and reflecting these allocation results in the expense storage unit.

Also, with an intellectual-property accounting management device according to the present invention, the research & development expenses allocation unit equally divides the research & development expenses of the relevant technical field for the worth of the number of intellectual properties belonging to the same technical field.

Also an intellectual-property accounting management device according to the present invention further comprises a weighting coefficient storage unit for storing a weighting coefficient for each intellectual property, and the research & development expenses allocation unit allocates the research & development expenses of the relevant technical field according to the ratio of the weighting coefficients possessed by the intellectual properties belonging to the same technical field.

Also an intellectual-property accounting management device according to the present invention further comprises a deferred-assets storage unit for storing, as deferred assets, the research & development expenses regarding an allocatable intellectual property not acquired, and the research & development expenses allocation unit starts allocation of the relevant research & development expenses, in the event that the intellectual property based on the research & development expenses which have become the deferred assets occurs.

Also an intellectual-property accounting management device according to the present invention further comprises a fixed-assets decision unit for determining regarding whether or not the book price is equal to or greater than a predetermined amount to be earmarked as fixed assets, and outputting fixed assets information.

According to this invention, determination regarding fixed assets can be made based on the newest book price, and also an intellectual property to be served as fixed assets can be readily understood, and can be earmarked as fixed assets in a sure manner.

Also, an intellectual-property accounting management device according to the present invention further comprises a fixed-assets storage unit for storing a book price for each intellectual property to be served as fixed assets, and the fixed-assets decision unit stores the book price equal to or greater than a predetermined amount in the fixed-assets storage unit.

Also, with an intellectual-property accounting management device according to the present invention, the acquisition year is the year when the relevant intellectual property was filed.

Also, with an intellectual-property accounting management device according to the present invention, the acquisition year is the year when the relevant intellectual property was subjected to the registration of rights.

Also, with an intellectual-property accounting management device according to the present invention, the expiration year is calculated based on a shorter period, of the duration of rights determined by the industrial property law, and the period determined by the tax law.

Also, with an intellectual-property accounting management device according to the present invention, the expiration year is calculated based on the shortest period, of the duration of rights determined by the industrial property law, or the period determined by the tax law, or the technical remaining life of the relevant intellectual property.

An intellectual-property accounting management program according to the present invention for performing intellectual property accounting processing in an intellectual-property accounting management device comprising a processing unit for performing various types of intellectual property accounting processing, and various types of storage units for storing various types of data to be used for intellectual property accounting management, causes a computer to execute: processing for inputting the amount of the acquisition expense expended for acquiring a particular intellectual property; acquisition price updating processing for updating the acquisition price stored in an acquisition price storage unit for storing an acquisition price for each intellectual property based on the input acquisition expense; and accounting management processing for performing intellectual property accounting processing based on the updated acquisition price.

Also, with an intellectual-property accounting management program according to the present invention, the acquisition price updating processing includes: processing for adding the input acquisition expense to the acquisition expense of the relevant fiscal year of the relevant intellectual property stored in an expense storage unit for storing an acquisition expense for each intellectual property for each fiscal year; processing for aggregating the acquisition expense stored in the expense storage unit for each intellectual property; and processing for storing each aggregated result in the acquisition price storage unit as the acquisition price of each relevant intellectual property.

Also, with an intellectual-property accounting management program according to the present invention, the expense storage unit stores the contents of the acquisition expense for each expense item, the intellectual-property accounting management device comprises a selected-item storage unit for storing items to be included in the acquisition price of an intellectual property, of the expense items, and a computer is further caused to execute processing for selecting expenses to be included in the acquisition price of an intellectual property in accordance with the setting contents of the selected-item storage unit.

Also, with an intellectual-property accounting management program according to the present invention, the expense items include at least two or more, of a refund fee to be paid to the creator of an intellectual property, research & development expenses, an attorney's fee to be paid to an attorney to which procedures according to an intellectual property are left, and a payment fee according to an intellectual property.

Also, with an intellectual-property accounting management program according to the present invention, the intellectual-property accounting management device comprises a technical-field storage unit for storing a technical field for each intellectual property, and a computer is further caused to execute research & development expenses allocation processing for allocating research & development expenses to be input for each technical field to each intellectual property belonged to the relevant technical field, and reflecting these allocation results in the expense storage unit.

Also, with an intellectual-property accounting management program according to the present invention, with the research & development expenses allocation processing, the research & development expenses of the relevant technical field for the worth of the number of intellectual properties belonging to the same technical field are divided equally.

Also, with an intellectual-property accounting management program according to the present invention, the intellectual-property accounting management device comprises a weighting coefficient storage unit for storing a weighting coefficient for each intellectual property, and with the research & development expenses allocation processing, the research & development expenses of the relevant technical field according to the ratio of the weighting coefficients possessed by the intellectual properties belonging to the same technical field are allocated.

Also, with an intellectual-property accounting management program according to the present invention, the intellectual-property accounting management device comprises a deferred-assets storage unit for storing, as deferred assets, the research & development expenses regarding an allocatable intellectual property not acquired, and with the research & development expenses allocation processing, allocation of the relevant research & development expenses is started, in the event that the intellectual property based on the research & development expenses which have become the deferred assets occurs.

Also, with an intellectual-property accounting management program according to the present invention, the accounting management processing includes processing for determining regarding whether or not the acquisition price is equal to or greater than a predetermined amount to be earmarked as fixed assets, and outputting fixed assets information.

Also, with an intellectual-property accounting management program according to the present invention, the accounting management processing includes processing for storing the acquisition price equal to or greater than a predetermined amount in a fixed-assets storage unit for storing an acquisition price for each intellectual property to be served as fixed assets.

Also, with an intellectual-property accounting management program according to the present invention, the accounting management processing includes processing for calculating depreciation and undepreciated balance for each intellectual property based on the acquisition price stored in the acquisition price storage unit and the depreciation period stored in a depreciation period storage unit for storing a depreciation period for each intellectual property.

Also, with an intellectual-property accounting management program according to the present invention, the accounting management processing includes: processing for calculating the differential amount between the depreciation stored in a depreciation expense storage unit for storing the newest depreciation calculated for each intellectual property for each fiscal year, and the depreciation stored in a previous depreciation expense storage unit for storing the previous depreciation calculated for each intellectual property for each fiscal year; and processing for aggregating the differential amount of the depreciation of all intellectual properties for each fiscal year based on the calculated differential amount of the depreciation.

An intellectual-property accounting management program according to the present invention further causes a computer to execute processing for inputting the acquisition year and expiration year of a particular intellectual property, and the accounting management processing includes processing for calculating the depreciation period of the relevant intellectual property based on the acquisition year and expiration year which were input.

An intellectual-property accounting management program according to the present invention for performing intellectual property accounting management processing in an intellectual-property accounting management device comprising a processing unit for performing various types of intellectual property accounting processing, and various types of storage units for storing various types of data to be used for intellectual property accounting management, causes a computer to execute: processing for inputting the amount of the acquisition expense expended for acquiring a particular intellectual property; processing for adding the input acquisition expense to the acquisition expense of the relevant fiscal year of the relevant intellectual property stored in an expense storage unit for storing an acquisition expense for each intellectual property for each fiscal year; processing for calculating the depreciation period from the previous year of a particular year based on the expiration year stored in an expiration year storage unit for storing an expiration year for each intellectual property; processing for calculating the depreciation expense of the previous year based on the calculated depreciation period, and the book price of the previous year stored in a book price storage unit for storing a book price for each intellectual property; and processing for subtracting the calculated depreciation expense of the previous year from the book price of the previous year, adding the acquisition expense of the particular year stored in the expense storage unit to this subtracted result, and storing this added result in the book price storage unit as the book price of the particular year.

Also, with an intellectual-property accounting management program according to the present invention, the expense storage unit stores the contents of the acquisition expense for each expense item, the intellectual-property accounting management device comprises a selected-item storage unit for storing items to be included in the book price of an intellectual property, of the expense items, and a computer is further caused to execute processing for selecting expenses to be included in the book price of an intellectual property in accordance with the setting contents of the selected-item storage unit.

Also, with an intellectual-property accounting management program according to the present invention, the expense items include at least two or more, of a refund fee to be paid to the creator of an intellectual property, research & development expenses, an attorney's fee to be paid to an attorney to which procedures according to an intellectual property are left, and a payment fee according to an intellectual property.

Also, with an intellectual-property accounting management program according to the present invention, the intellectual-property accounting management device comprises a technical-field storage unit for storing a technical field for each intellectual property, and a computer is further caused to execute research & development expenses allocation processing for allocating research & development expenses to be input for each technical field to each intellectual property belonged to the relevant technical field, and reflecting these allocation results in the expense storage unit.

Also, with an intellectual-property accounting management program according to the present invention, with the research & development expenses allocation processing, the research & development expenses of the relevant technical field for the worth of the number of intellectual properties belonging to the same technical field are divided equally.

Also, with an intellectual-property accounting management program according to the present invention, the intellectual-property accounting management device comprises a weighting coefficient storage unit for storing a weighting coefficient for each intellectual property, and with the research & development expenses allocation processing, the research & development expenses of the relevant technical field are allocated according to the ratio of the weighting coefficients possessed by the intellectual properties belonging to the same technical field.

Also, with an intellectual-property accounting management program according to the present invention, the intellectual-property accounting management device comprises a deferred-assets storage unit for storing, as deferred assets, the research & development expenses regarding an allocatable intellectual property not acquired, and with the research & development expenses allocation processing, allocation of the relevant research & development expenses is started, in the event that the intellectual property based on the research & development expenses which have become the deferred assets occurs.

Also, with an intellectual-property accounting management program according to the present invention, a computer is further caused to execute processing for determining regarding whether or not the book price is equal to or greater than a predetermined amount to be earmarked as fixed assets, and outputting fixed assets information.

Also, with an intellectual-property accounting management program according to the present invention, a computer is further caused to execute processing for storing the book price equal to or greater than a predetermined amount in a fixed-assets storage unit for storing a book price for each intellectual property to be served as fixed assets.

According to the above intellectual-property accounting management program, the above intellectual-property accounting management device can be realized using a computer.

### BRIEF DESCRIPTION OF THE DRAWINGS

FIG. 1 is a block diagram illustrating the hardware configuration of an intellectual-property accounting management device according to an embodiment of the present invention.

FIG. 2 is a block diagram illustrating the functional configuration of an intellectual-property accounting management device according to a first embodiment.

FIG. 3 is a diagram illustrating a configuration example of an expense storage unit 201.

FIG. 4 is a diagram illustrating a configuration example of an acquisition price storage unit 202.

FIG. 5 is a diagram illustrating a configuration example of a fixed-assets storage unit 203.

FIG. 6 is a diagram illustrating a configuration example of a depreciation period storage unit 204.

FIG. 7 is a diagram illustrating a configuration example of a depreciation expense storage unit 205.

FIG. 8 is a diagram illustrating a configuration example of a previous depreciation expense storage unit 206.

FIG. 9 is a diagram illustrating a configuration example of depreciation expense total differential amount information.

FIG. 10 is a block diagram illustrating the functional configuration of an intellectual-property accounting management device according to a second embodiment.

FIG. 11 is a diagram illustrating a configuration example of an expiration year storage unit 211.

FIG. 12 is a diagram illustrating a configuration example of a book price storage unit 212.

FIG. 13 is a block diagram illustrating the functional configuration of an intellectual-property accounting management device according to a third embodiment.

FIG. 14 is a diagram illustrating a configuration example of an itemized-expense storage unit 201a.

FIG. 15 is a diagram illustrating a configuration example of a selected-item storage unit 2001.

FIG. 16 is a block diagram illustrating the functional configuration of an intellectual-property accounting management device according to a fourth embodiment.

FIG. 17 is a block diagram illustrating the functional configuration of an intellectual-property accounting management device according to a fifth embodiment.

FIG. 18 is a block diagram illustrating one configuration of a research & development expenses management unit 1100.

FIG. 19 is a block diagram illustrating another configuration of the research & development expenses management unit 1100.

FIG. 20 is a block diagram illustrating another configuration of the research & development expenses storage unit 1100.

FIG. 21 is a diagram illustrating a configuration example of a technical-field storage unit 2101a shown in FIG. 18.

FIG. 22 is a diagram illustrating a configuration example of a technical-field & weighting-coefficient storage unit 2101b shown in FIG. 19.

FIG. 23 is a diagram illustrating a configuration example of a deferred-assets storage unit 2110 shown in FIG. 20.

### BEST MODE FOR CARRYING OUT THE INVENTION

Description will be made below regarding an embodiment of the present invention with reference to the drawings.

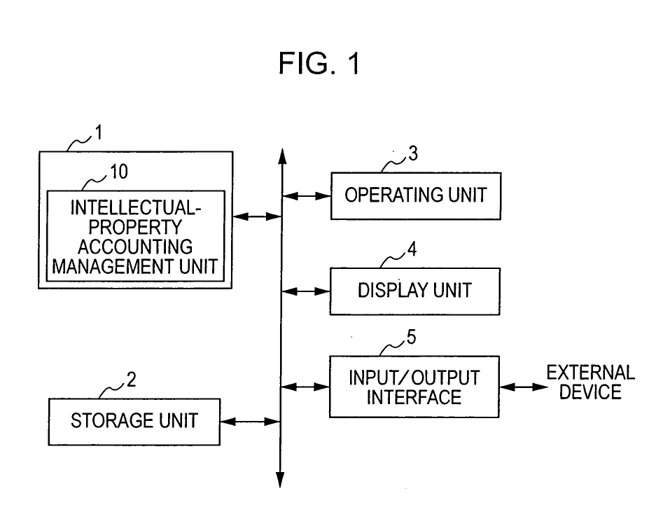

FIG. 1 is a block diagram illustrating the hardware configuration of an intellectual-property accounting management device according to an embodiment of the present invention. In FIG. 1, the intellectual-property accounting management device comprises a processing unit 1, a storage unit 2, an operating unit 3, a display unit 4, and an input/output interface 5. The respective units 1 through 5 are connected via bus. The processing unit 1 includes an intellectual-property accounting management unit 10 for performing various types of intellectual property accounting processing. The storage unit 2 stores various types of data to be used for intellectual property accounting management. The operating unit 3 comprises an input device such as a keyboard, a mouse, and so forth for an operator inputting data. The display unit 4 comprises a display device (CRT (Cathode Ray Tube), liquid crystal display device, and so forth) for displaying data. The input/output interface 5 is connected with an external device such as a printing device, a read/write device to a recording medium (flexible disk and so forth), and so forth, and performs input/output of data. Also, an arrangement may be made wherein the input/output interface 5 includes a communication function, connects to an external computer via a communication line, and sends/receives data.

Each embodiment of the intellectual-property accounting management device, which is realized by the hardware configuration shown in FIG. 1, will be described in order, thereinafter.

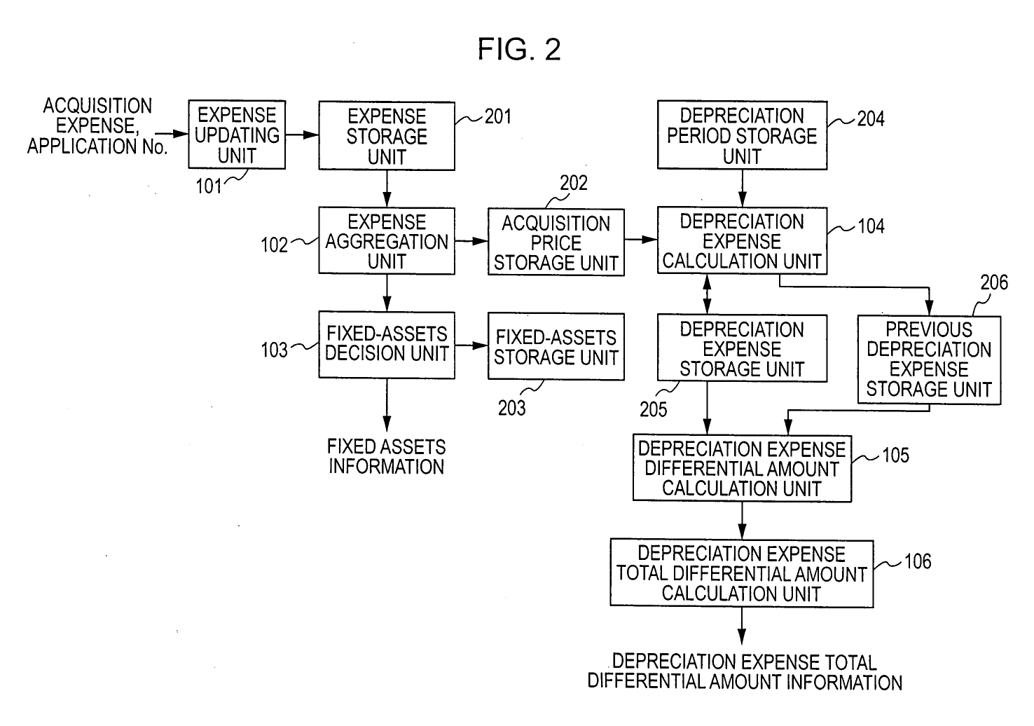

FIG. 2 is a block diagram illustrating the functional configuration of an intellectual-property accounting management device according to a first embodiment. In FIG. 2, the intellectual-property accounting management device comprises an expense updating unit 101, an expense aggregation unit 102, a fixed-assets decision unit 103, a depreciation expense calculation unit 104, a depreciation expense differential amount calculation unit 105, a depreciation expense total differential amount calculation unit 106, an expense storage unit 201, an acquisition price storage unit 202, a fixed-assets storage unit 203, a depreciation period storage unit 204, a depreciation expense storage unit 205, and a previous depreciation expense storage unit 206. The above respective units 101 through 106 are included in the intellectual-property accounting management unit 10 in FIG. 1. Also, the above respective units 201 through 206 are included in the storage unit 2 in FIG. 1.

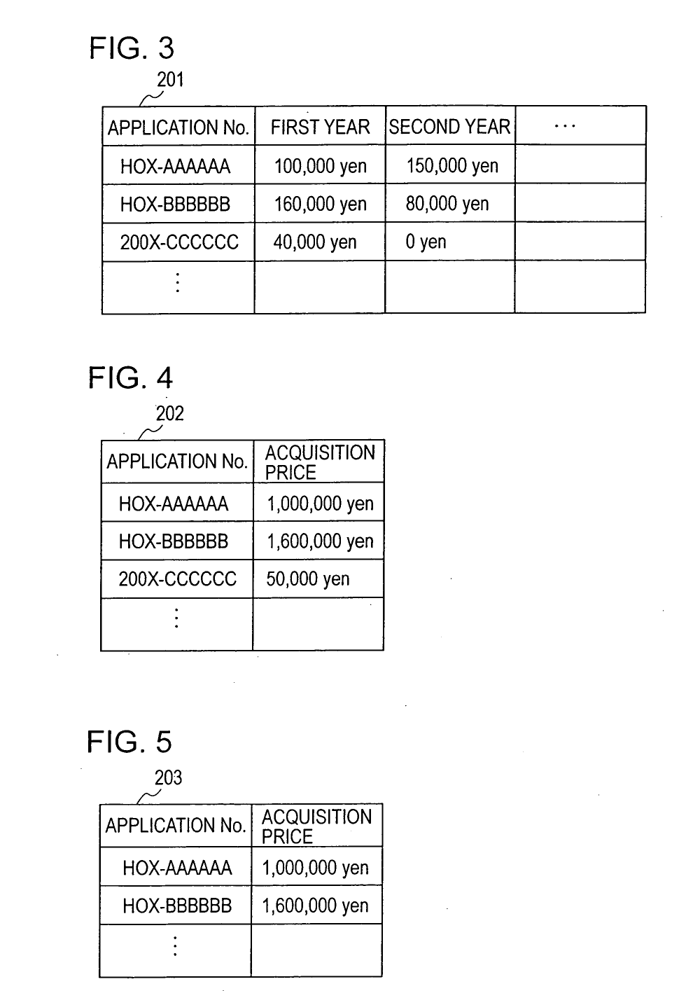

FIG. 3 is a diagram illustrating a configuration example of the expense storage unit 201. The expense storage unit 201 stores an acquisition expense for each intellectual property for each fiscal year. The term “acquisition expense” means the amount of an acquisition expense expended for acquiring a particular intellectual property. An acquisition expense includes refund paid to an inventor. Examples of refund paid to the inventor of an intellectual property by a company (applicant) include “refund as to filing of the intellectual property”, “refund as to registration of rights of the intellectual property”, “refund as to implementation of the intellectual property”, “refund as to grant of license of the intellectual property rights”, and so forth. Also, an acquisition expense may include the amount of research & development expenses.

As shown in FIG. 3, the acquisition expense of each intellectual property is correlated with the application number thereof, and stored for each fiscal year. For example, the acquisition expense earmarked in the fiscal year (first year) of the intellectual property of an application number “H0X-AAAAAA” is “100,000 yen”, and the acquisition expense earmarked in the fiscal year (second year) is “150,000 yen”.

Note that with the present embodiment, the application number of an intellectual property is employed as the management number of the relevant intellectual property.

FIG. 4 is a diagram illustrating a configuration example of the acquisition price storage unit 202. The acquisition price storage unit 202 stores an acquisition price for each intellectual property. The term “acquisition price” means the total amount of acquisition expenses expended for acquiring a particular intellectual property. As shown in FIG. 4, the acquisition price of each intellectual property is correlated with the application number thereof, and stored. For example, the acquisition price of the intellectual property of the application number “H0X-AAAAAA” is “1,000,000 yen”, and the acquisition price of the intellectual property of an application number “200X-CCCCCC” is “50,000 yen”.

FIG. 5 is a diagram illustrating a configuration example of the fixed-assets storage unit 203. The fixed-assets storage unit 203 stores an acquisition price for each intellectual property to be served as fixed assets. The term “intellectual property to be served as fixed assets” means an intellectual property of which the acquisition price is equal to or greater than a predetermined amount (e.g., 200,000 yen). As shown in FIG. 5, the acquisition price of each intellectual property to be served as fixed assets is correlated with the application number thereof, and stored. For example, the acquisition price “1,000,000 yen” of the intellectual property of the application number “H0X-AAAAAA” is equal to or greater than a predetermined amount (200,000 yen) to be earmarked as fixed assets, and stored in the fixed-assets storage unit 203.

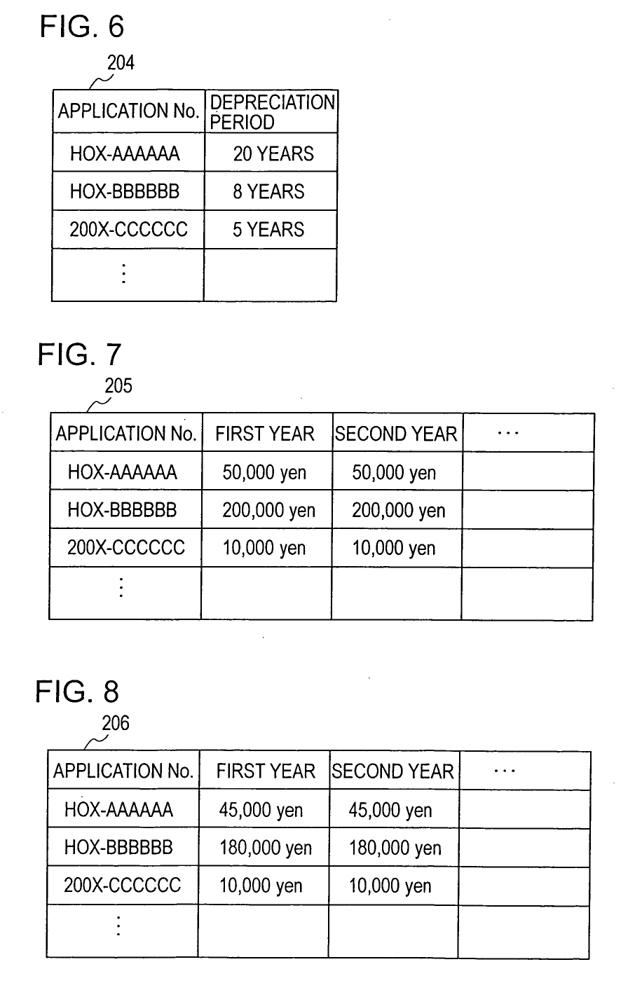

FIG. 6 is a diagram illustrating a configuration example of the depreciation period storage unit 204. The depreciation period storage unit 204 stores a depreciation period for each intellectual property. The term “depreciation period” means a depreciating period calculated as a period between the acquisition year and the expiration year of a particular intellectual property. The term “the acquisition year of an intellectual property” means the year when an intellectual property was acquired, e.g., the year when the relevant intellectual property was filed. Alternately, the year when the relevant intellectual property was subjected to registration of rights may be employed as the acquisition year of the intellectual property.

The term “extinction year” means a year when the worth of an intellectual property is lost, and is calculated as a year when duration wherein the worth of an intellectual property exists has been elapsed since the acquisition year. As for duration wherein the worth of an intellectual property exists, for example, the duration of rights (e.g., 20 years in the case of a patent) determined by the industrial property law, the duration determined by the tax law (8 years), the technical remaining life of an intellectual property, and so forth are available. The term “the technical remaining life of an intellectual property” means an estimated life period in the technical life cycle or design life cycle of the relevant intellectual property. Also, of the duration of rights determined by the industrial property law, and the duration determined by the tax law, a shorter period may be employed as the duration wherein the worth of an intellectual property exists. Alternately, of the duration of rights determined by the industrial property law, the duration determined by the tax law, and the technical remaining life of the relevant intellectual property, the shortest period may be employed as the duration wherein the worth of an intellectual property exists.

As shown in FIG. 6, the depreciation period of each intellectual property is correlated with the application number thereof, and stored. For example, the depreciation period of the intellectual property of the application number “H0X-AAAAAA” is 20 years (duration of a patent).

FIG. 7 is a diagram illustrating a configuration example of the depreciation expense storage unit 205. The depreciation expense storage unit 205 stores the newest depreciation calculated for each intellectual property, for each fiscal year. As shown in FIG. 7, the newest depreciation of each intellectual property is correlated with the application number thereof, and stored for each fiscal year. For example, the newest depreciations of the fiscal years “first year” and “second year” of the intellectual property of the application number “H0X-AAAAAA” are both “50,000 yen”.

FIG. 8 is a diagram illustrating a configuration example of the previous depreciation expense storage unit 206. The previous depreciation expense storage unit 206 stores the depreciation previously calculated for each intellectual property, for each fiscal year. As shown in FIG. 8, the previous depreciation of each intellectual property is correlated with the application number thereof, and stored for each fiscal year. For example, the previous depreciations of the fiscal years “first year” and “second year” of the intellectual property of the application number “H0X-AAAAAA” are both “45,000 yen”.

Next, description will be made regarding operations of the intellectual-property accounting management device according to the first embodiment shown in FIG. 2.

First, upon the acquisition expense of a particular intellectual property being input from the operating unit 3 along with the application number thereof, the expense updating unit 101 adds the input acquisition expense to the acquisition expense of the relevant fiscal year (this year, here) of the relevant intellectual property stored in the expense storage unit 201. Incidentally, an acquisition expense may be input by specifying the fiscal year.

Subsequently, the expense aggregation unit 102 aggregates the acquisition expenses stored in the expense storage unit 201 for each intellectual property, and stores each aggregated result in the acquisition price storage unit 202 as the acquisition price of each relevant intellectual property. Thus, the acquisition price of each intellectual property is updated. Incidentally, this acquisition price updating processing may be performed on a certain date. For example, this processing may be performed on a certain date biannually, or a certain date quarterly.

The fixed-assets decision unit 103 determines regarding whether or not the updated acquisition price is equal to or greater than a predetermined amount (e.g., 200,000 yen) to be earmarked as fixed assets, and outputs fixed assets information based on this determined result. For example, the application number of an intellectual property newly serving as fixed assets, and the acquisition price thereof are displayed or printed out as fixed assets information. Thus, a manager can readily understand intellectual properties serving as fixed assets, and can earmark these as fixed assets in a sure manner.

Further, the fixed-assets decision unit 103 correlates the acquisition price equal to or greater than the predetermined amount with the application number of the relevant intellectual property, and stores this in the fixed-assets storage unit 203. Thus, the fixed assets information regarding intellectual properties can be automatically recorded.

Upon the acquisition price being updated by the expense aggregation unit 102, the depreciation expense calculation unit 104 calculates depreciation and undepreciated balance for each intellectual property based on the acquisition price stored in the acquisition price storage unit 202, and the depreciation period stored in the depreciation period storage unit 204. Here, the depreciation expense calculation unit 104 calculates depreciation and undepreciated balance in accordance with a certain depreciation rule. For example, the depreciation of each fiscal year is calculated using the fixed installment method so as to depreciate a constant amount every year.

Subsequently, the depreciation expense calculation unit 104 updates the depreciation of each fiscal year of each intellectual property in the depreciation expense storage unit 205 based on the calculated depreciation. Here, the depreciation expense calculation unit 104 copies the depreciation of each fiscal year of each intellectual property prior to update of the depreciation expense storage unit 205 to the previous depreciation expense storage unit 206. Thus, the depreciation expense storage unit 205 stores the newest depreciation calculated for each intellectual property, for each fiscal year. Also, the previous depreciation expense storage unit 206 stores the previous depreciation calculated for each intellectual property, for each fiscal year.

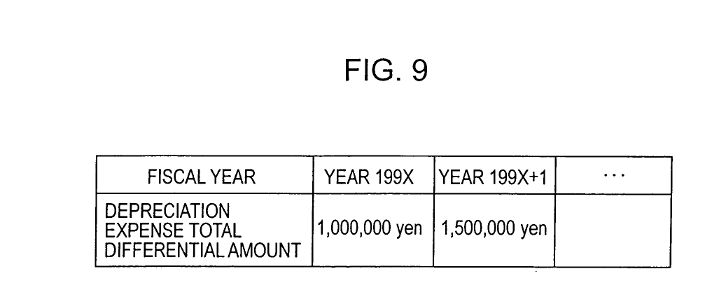

Subsequently, the depreciation expense differential amount calculation unit 105 calculates the differential amount between the depreciation stored in the depreciation expense storage unit 205 and the depreciation stored in the previous depreciation expense storage unit 206, for each fiscal year. Subsequently, the depreciation expense total differential amount calculation unit 106 aggregates the differential amount of the depreciation expenses of all the intellectual properties for each fiscal year based on the calculated differential amount of the depreciation. An example of the aggregated result (depreciation expense total differential amount) for each fiscal year is shown in FIG. 9. The depreciation expense differential amount calculation unit 105 displays or prints out this depreciation expense total differential amount information. Thus, a manager can readily understand the total differential amount from the depreciation expense of the previous year, for each fiscal year, thereby improving efficiency of accounting processing.

Incidentally, accounting information such as acquisition price, depreciation expenses, and undepreciated balance may be displayed or printed out.

As described above, according to the first embodiment, the acquisition price of the relevant intellectual property can be updated based on the amount of the acquisition expense newly added. According to this acquisition price following update, intellectual property accounting processing such as calculation of the depreciation expense of the relevant intellectual property from the acquisition year, and determination regarding fixed assets can be performed. Thus, intellectual property accounting management can be handled.

Also, an acquisition expense is stored for each intellectual property for each fiscal year, whereby the acquisition expense of each fiscal year of an intellectual property can be managed.

Also, the differential amount of the depreciation expenses of all the intellectual properties is aggregated for each fiscal year, so the total differential amount from the depreciation expenses of the previous year can be readily understood for each fiscal year, thereby improving efficiency of accounting processing.

Also, an arrangement may be made wherein the acquisition year and expiration year of a particular intellectual property are input (corresponding to a depreciation period calculation information input unit), and the intellectual-property accounting management unit calculates the depreciation period of the relevant intellectual property based on the acquisition year and expiration year which were input (corresponding to a depreciation period calculation unit). Thus, the depreciation period of an intellectual property can be automatically calculated from the acquisition year and the expiration year.

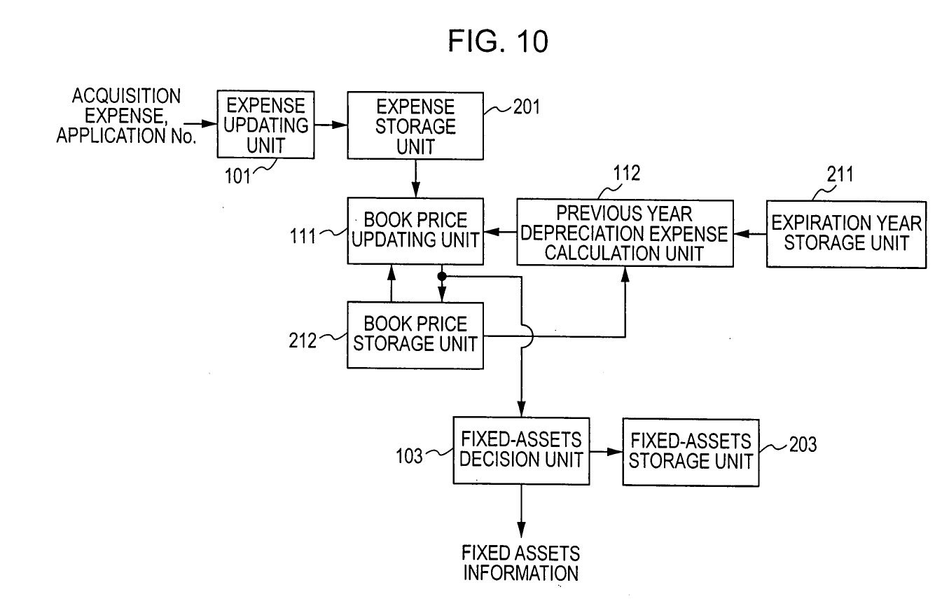

Next, description will be made regarding a second embodiment. FIG. 10 is a block diagram illustrating the functional configuration of an intellectual-property accounting management device according to the second embodiment. In FIG. 10, the intellectual-property accounting management device comprises an expense updating unit 101, a fixed-assets decision unit 103, a book price updating unit 111, a previous year depreciation expense calculation unit 112, an expense storage unit 201, a fixed-assets storage unit 203, a expiration year storage unit 211, and a book price storage unit 212. The above respective units 101, 103, 111, and 112 are included in the intellectual-property accounting management unit 10 in FIG. 1. Also, the above respective storage units 201, 203, 211, and 212 are included in the storage unit 2 in FIG. 1. Note that in FIG. 10, the components corresponding to the respective components in FIG. 2 will be denoted with the same reference numerals, and the description thereof will be omitted.

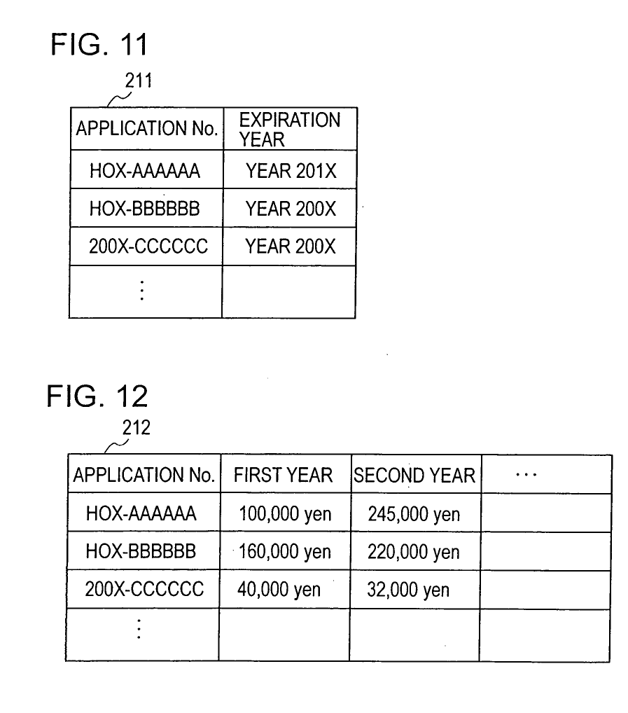

FIG. 11 is a diagram illustrating a configuration example of the expiration year storage unit 211. The expiration year storage unit 211 stores an expiration year for each intellectual property. As shown in FIG. 11, the expiration year of each intellectual property is correlated with the application number thereof, and stored. For example, the expiration year of the intellectual property of the application number “H0X-AAAAAA” is “YEAR 201X”.

FIG. 12 is a diagram illustrating a configuration example of the book price storage unit 212. The book price storage unit 212 stores an extinction year for each intellectual property. As shown in FIG. 12, the book price of each intellectual property is correlated with the application number thereof, and stored for each fiscal year. For example, the book price of the fiscal year “first year” of the intellectual property of the application number “H0X-AAAAAA” is “100,000 yen”, and the book price of the fiscal year “second year” is “245,000 yen”.

Note that the fixed-assets storage unit 203 stores a book price for each intellectual property to be served as fixed assets.

Next, description will be made regarding operations of the intellectual-property accounting management device according to the second embodiment shown in FIG. 10.

First, upon the acquisition expense of a particular intellectual property being input from the operating unit 3 along with the application number thereof, the expense updating unit 101 updates the acquisition expense stored in the expense storage unit 201 based on the input acquisition expense, as with the above first embodiment.

The previous year depreciation expense calculation unit 112 calculates the depreciation expense from the previous year (year 2001) of a particular year (here, let us say year 2002) based on the expiration year stored in the expiration year storage unit 211. The above particular year is the fiscal year wherein new book price is calculated. Here, the period from year 2001 to the expiration year is calculated as a depreciation period. Subsequently, the previous year depreciation expense calculation unit 112 calculates the depreciation expense of the previous year (year 2001) from the depreciation period thereof and the book price of the previous year (year 2001) stored in the book price storage unit 212 using the fixed installment method for example.

Subsequently, the book price updating unit 111 subtracts the calculated depreciation expense of the previous year (year 2001) from the book price of the previous year (year 2001), and adds the acquisition expense of the particular year (year 2002) stored in the expense storage unit 201 to the subtracted result. Subsequently, this added result is stored in the book price storage unit 212 as the book price of the particular year (year 2002).

Note that this book price updating processing may be performed on a certain date. For example, this may be performed on a certain date biannually, or a certain date quarterly.

The fixed-assets decision unit 103 determines regarding whether or not the book price is equal to or greater than a predetermined amount (e.g., 200,000 yen) to be served as fixed assets, and outputs fixed assets information based on this determined result. For example, the application number of the intellectual property newly serving as fixed assets, and the book price thereof are displayed or printed out as fixed assets information. Further, the fixed-assets decision unit 103 correlates the book price equal to or greater than the predetermined amount with the application number of the relevant intellectual property, and stores this in the fixed-assets storage unit 203.

As described above, according to the second embodiment, the book price of the relevant fiscal year of the relevant intellectual property can be updated based on the amount of an acquisition expense newly added. Thus, the depreciation expense from the acquisition expense additional year onwards can be calculated based on the book price updated, so the depreciation expense theretofore needs not to be updated. Also, determination can be made regarding fixed assets based on the newest book price.

Note that, with the above embodiment, the acquisition expense and the depreciation period calculation information (acquisition year and expiration year) of a particular intellectual property may be input from the operating unit 3, or may be input from an external computer or an input terminal using the input/output interface 5 via a communication line. With the above embodiment, the operating unit 3 and the input/output interface 5 correspond to an acquisition expense input unit and a depreciation period calculation information input unit.

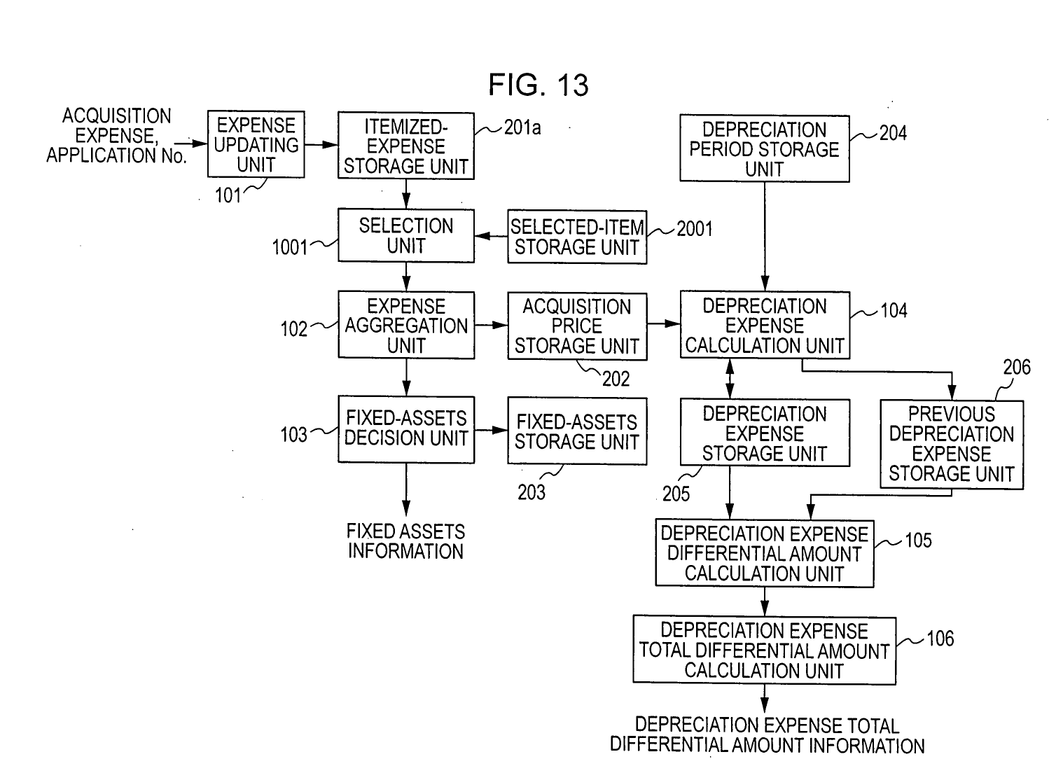

Next, description will be made regarding a third embodiment. FIG. 13 is a block diagram illustrating the functional configuration of an intellectual-property accounting management device according to the third embodiment. In FIG. 13, the components corresponding to the respective components in FIG. 2 will be denoted with the same reference numerals, and the description thereof will be omitted. The intellectual-property accounting management device shown in FIG. 13, in addition to the configuration of the intellectual-property accounting management device in FIG. 2, further comprises a selection unit 1001 and a selected-item storage unit 2001, and also comprises an itemized-expense storage unit 201a instead of the expense storage unit 201 shown in FIG. 2.

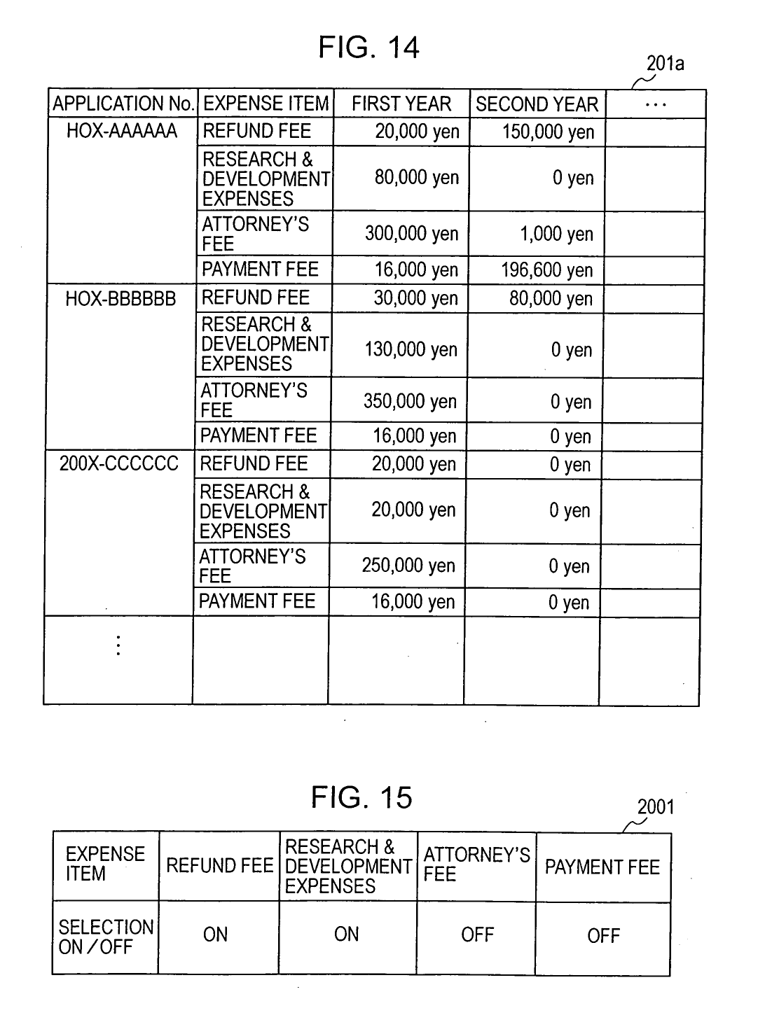

FIG. 14 is a diagram illustrating a configuration example of the itemized-expense storage unit 201a. As shown in FIG. 14, the itemized-expense storage unit 201a stores an acquisition expense for each intellectual property for each fiscal year as with the expense storage unit 201 in FIG. 3, but stores the contents of the acquisition expense for each expense item. Examples of the expense items include a refund fee to be paid to the creator (e.g., inventor) of an intellectual property (compensation on filing, compensation at the registration, performance incentive, and so forth), research & development expenses necessary for research and development for creating intellectual properties, an attorney's fee to be paid to an attorney to which procedures according to an intellectual property are left, and a payment fee according to an intellectual property (filing fee, examination request fee, patent fee, and so forth).

FIG. 15 is a diagram illustrating a configuration example of the selected-item storage unit 2001. Of the above expense items (refund fee, research & development expenses, attorney's fee, and payment fee), the selected-item storage unit 2001 stores the items to be included in the acquisition price of an intellectual property. With the example in FIG. 15, items to be included in the acquisition price are represented with selection ON, and items not to be included in the acquisition price are represented with selection OFF.

Next, description will be made regarding operations of the intellectual-property accounting management device according to the third embodiment shown in FIG. 13. Here, only the characteristic operations in the third embodiment, which are different from the intellectual-property accounting management device in FIG. 2, will be described.

In FIG. 13, upon an acquisition expense being input, the expense updating unit 101 updates the itemized-expense storage unit 201a for each expense item. Subsequently, the selection unit 1001 selects only the acquisition expenses of the expense items to be included in the acquisition price of an intellectual property, of the acquisition expenses of the itemized-expense storage unit 201a, and outputs these to the expense aggregation unit 102. At this selection time, the selected-item storage unit 2001 is referenced. That is to say, the selection unit 1001 selects only the acquisition expenses of the expense items, which are set as selected-items at the selected-item storage unit 2001. With the example in FIG. 15, a refund fee and research & development expenses, which are set as selection ON, become selected items. Subsequently, the expense aggregation unit 102 aggregates the acquisition expenses input from the selection unit 1001 for each intellectual property, and stores each aggregated result in the acquisition price storage unit 202 as the acquisition price of each relevant intellectual property.

According to the above third embodiment, the expense items to be earmarked as the acquisition price of an intellectual property can be altered by modifying the setting contents of the selected-item storage unit 2001, thereby flexibly handling any modification, even if the types of expense items to be earmarked are altered due to modifications of an accounting system and so forth.

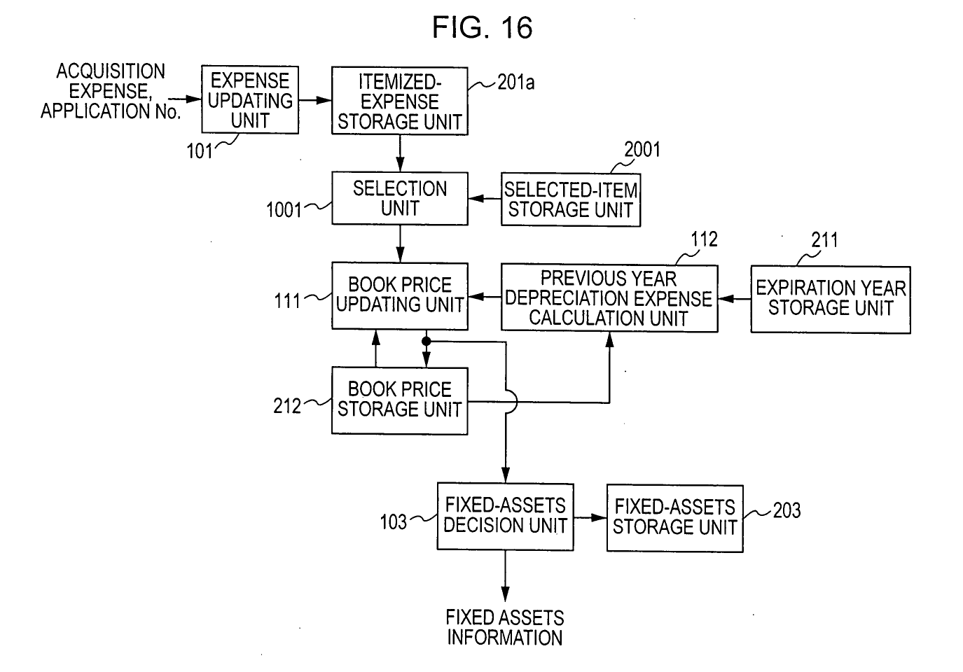

Note that the above third embodiment has been applied to the intellectual-property accounting management device in FIG. 2, but similarly, this can be applied to the intellectual-property accounting management device (second embodiment) in FIG. 10, which is referred to as a fourth embodiment, hereafter. FIG. 16 is a block diagram illustrating the functional configuration of an intellectual-property accounting management device according to the fourth embodiment. With the intellectual-property accounting management device in FIG. 16, the expense items to be included in the book price of an intellectual property are stored in the selected-item storage unit 2001. Subsequently, the selection unit 1001 selects only the acquisition expenses of the expense items to be included in the book price of an intellectual property, of the acquisition expenses in the itemized-expense storage unit 201a, in accordance with the setting contents of the selected-item storage unit 2001, and outputs these to the book price updating unit 111.

According to this configuration, the expense items to be earmarked as the book price of an intellectual property can be altered by modifying the setting contents of the selected-item storage unit 2001.

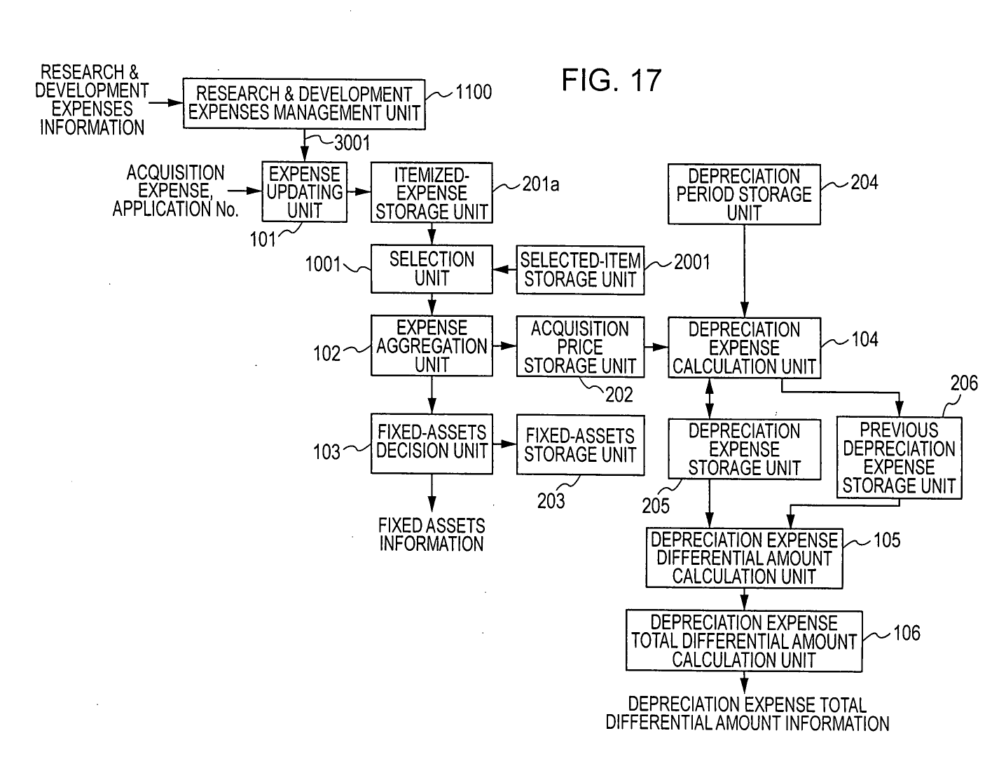

Next, description will be made regarding a fifth embodiment. FIG. 17 is a block diagram illustrating the functional configuration of an intellectual-property accounting management device according to the fifth embodiment. In FIG. 17, the components corresponding to the respective components in FIG. 13 will be denoted with the same reference numerals, and the description thereof will be omitted. The intellectual-property accounting management device shown in FIG. 17 further comprises a research & development expenses management unit 1100, in addition to the configuration of the intellectual-property accounting management device in FIG. 13. The configuration and operations except for this research & development expenses management unit 1100 are the same as those of the third embodiment shown in FIG. 13.

Of the acquisition expense information, information according to research & development expenses is input to the research & development expenses management unit 1100. This research & development expenses information includes research & development expenses and the relevant research & development technical field. The research & development expenses management unit 1100 appropriately allocates the input research & development expenses as to the intellectual properties belonged to the relevant research & development technical field. The expense updating unit 101 updates the research & development expenses of the relevant intellectual properties of the itemized-expense storage unit 201a based on this allocation amount 3001.

The embodiments of this research & development expenses management unit 1100 will be described in order, thereinafter.

### Embodiment A of the Research & Development Expenses Management Unit 1100

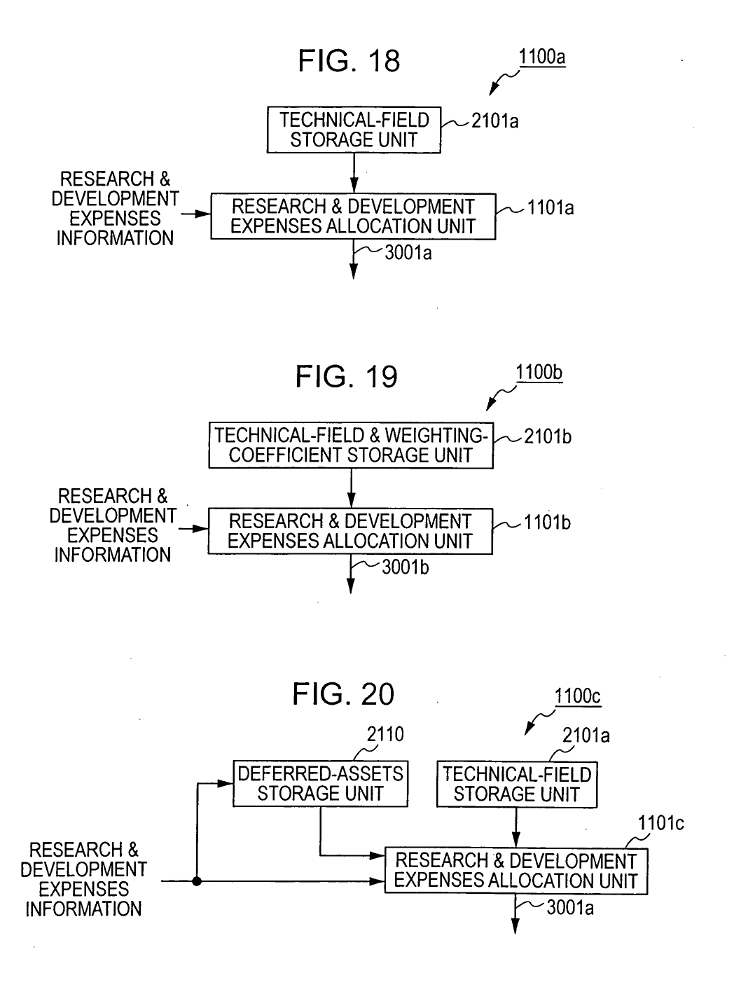

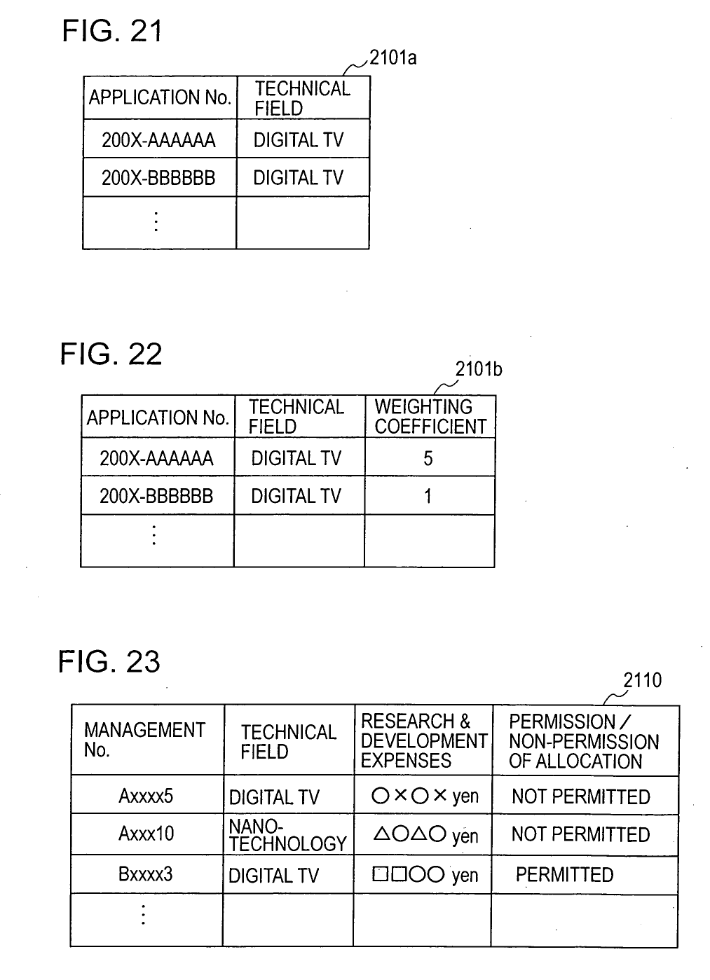

First, an embodiment of the research & development expenses management unit 1100 will be described with reference to FIG. 18 and FIG. 21. FIG. 18 is a block diagram illustrating the configuration of a research & development expenses storage unit 1100a according to this embodiment. FIG. 21 is a diagram illustrating a configuration example of a technical-field storage unit 2101a shown in FIG. 18. In FIG. 18, the research & development expenses storage unit 1100a comprises a research & development expenses allocation unit 1101a and a technical-field storage unit 2101a.

As shown in FIG. 21, the technical-field storage unit 2101a stores technical fields to which each intellectual property belongs. Upon research & development expenses information (research & development expenses and a technical field) being input, the research & development expenses allocation unit 1101a obtains the number of intellectual properties belonged to the input technical field with reference to the technical-field storage unit 2101a. Subsequently, the research & development expenses allocation unit 1101a calculates an allocation amount 3001a per one intellectual property by dividing the input research & development expenses by the obtained number. Subsequently, the research & development expenses allocation unit 1101a outputs the allocation amount 3001a to the expense updating unit 101. Subsequently, the expense updating unit 101 adds the allocation amount 3001a to the research & development expenses of the relevant intellectual property in the itemized-expense storage unit 201a to update the research & development expenses.

With this embodiment A, the research & development expenses are equally allocated to each intellectual property belonged to the relevant technical field. Thus, the allocation amount of the research & development expenses can be calculated easily.

### Embodiment B of the Research & Development Expenses Management Unit 1100

Next, another embodiment of the research & development expenses management unit 1100 will be described with reference to FIG. 19 and FIG. 22. FIG. 19 is a block diagram illustrating the configuration of a research & development expenses storage unit 1100b according to this embodiment. FIG. 22 is a diagram illustrating a configuration example of a technical-field & weighting-coefficient storage unit 2101b shown in FIG. 19. In FIG. 19, the research & development expenses storage unit 1100b comprises a research & development expenses allocation unit 1101b and a technical-field & weighting-coefficient storage unit 2101b.

As shown in FIG. 22, the technical-field & weighting-coefficient storage unit 2101b stores the technical field and weighting coefficient of an intellectual property for each intellectual property. This weighting coefficient is set according to the level of importance of an intellectual property. Upon research & development expenses information (research & development expenses and a technical field) being input, the research & development expenses allocation unit 1101b obtains the sum of the weighting coefficients of intellectual properties belonged to the input technical field with reference to the technical-field & weighting-coefficient storage unit 2101b. Subsequently, the research & development expenses allocation unit 1101b divides the input research & development expenses by the obtained sum to calculate the research & development expenses per unit of weighting coefficient. Subsequently, the research & development expenses allocation unit 1101b calculates an allocation amount 3001b as to each intellectual property by multiplying the weighting coefficient of each of intellectual property belonged to the relevant technical field by the research & development expenses per unit of weighting coefficient. Subsequently, the research & development expenses allocation unit 1101b outputs the allocation amount 3001b to the expense updating unit 101. Subsequently, the expense updating unit 101 adds the allocation amount 3001b to the research & development expenses of the relevant intellectual property in the itemized-expense storage unit 201a to update the research & development expenses.

With this embodiment B, the research & development expenses are allocated to each intellectual property belonged to the relevant technical field according to each weighting coefficient ratio. Thus, allocation of the research & development expenses can be performed according to the level of importance of each intellectual property.

### Embodiment C of the Research & Development Expenses Management Unit 1100

Next, another embodiment of the research & development expenses management unit 1100 will be described with reference to FIG. 20 and FIG. 23. FIG. 20 is a block diagram illustrating the configuration of a research & development expenses storage unit 1100c according to this embodiment. FIG. 23 is a diagram illustrating a configuration example of a deferred-assets storage unit 2110 shown in FIG. 20. In FIG. 20, the research & development expenses storage unit 1100c comprises a research & development expenses allocation unit 1101c, a deferred-assets storage unit 2110, and a technical-field storage unit 2101a in FIG. 21.

The deferred-assets storage unit 2110 stores the research & development expenses not acquired by an allocatable intellectual property as deferred assets. With the example in FIG. 23, the technical field, the research & development expenses serving as deferred assets, and regarding whether or not allocation can be performed are stored, which are correlated with the management number of the research & development expenses.

With this embodiment C, information regarding whether or not the relevant research & development expenses can be allocated is further input as research & development expenses information, in addition to the research & development expenses and the technical field. With regard to the research & development expenses which cannot be allocated according to this allocation enable/disable information, allocation is not performed, and stored in the deferred-assets storage unit 2110 as allocation disable information. Also, in the case in which an intellectual property based on the research & development expenses serving as deferred assets occurs, allocation enable information is input as the research & development expenses information. According to this allocation enable information, the research & development expenses which were not allocatable are updated to the research & development expenses which are allocatable at the deferred-assets storage unit 2110. Thus, the research & development expenses allocation unit 1101c starts allocation of the research & development expenses, which were deferred assets.

The research & development expenses allocation unit 1101c performs allocation regarding the allocatable research & development expenses, of the input research & development expenses, and the allocatable research & development expenses, of the research & development expenses in the deferred-assets storage unit 2110. Following this allocation, the research & development expenses allocation unit 1101c deletes the allocatable research & development expenses in the deferred-assets storage unit 2110 from the deferred-assets storage unit 2110. With the embodiment in FIG. 20, as with the embodiment in FIG. 18, the research & development expenses are equally divided and allocated to each intellectual property belonged to the relevant technical field. Note that, as with the embodiment in FIG. 19, an arrangement may be made wherein a technical-field & weighting-coefficient storage unit 2101b is further included, and the research & development expenses are allocated to each intellectual property belonged to the relevant technical field according to each weighting coefficient ratio.

According to this embodiment C, even the research & development expenses of which allocation time is not fixed can be handled. Heretofore, depreciation has not been able to be started in the case wherein assets which are not put into business cannot be depreciated, and it takes long for the assets to be put into business in research and development. However, according to this embodiment, depreciation can be started simply by regarding the acquisition time of an intellectual property as the time when the intellectual property is put into business.

According to the above fifth embodiment, the research & development expenses can be appropriately accounting-earmarked as the acquisition price of the relevant intellectual property. Heretofore, regardless of increase of the ratio of company earnings depending on intellectual property rights, research & development expenses are regarded as expenses, the intellectual properties self-created are not earmarked as assets, and consequently, the misfit width between the current price total amount of a stock company and the net assets book price on accounting indicated by the balance sheet has increased. However, research & development expenses are appropriately earmarked as a part of the acquisition price of an intellectual property, and depreciated by providing the research & development expenses management unit 1100, thereby reducing the misfit width between the current price total amount of a stock company and the net assets book price on accounting.

Note that the above fifth embodiment has been applied to the intellectual-property accounting management device in FIG. 13, but can be applied to the intellectual-property accounting device in FIG. 16 in the same way.

An arrangement may be made wherein a program for realizing each processing performed by the intellectual-property accounting management device shown in any one of FIG. 2, FIG. 10, FIG. 13, FIG. 16, and FIG. 17 is recorded in a computer-readable recording medium, the program recorded in this recording medium is read into a computer system, and executed, thereby performing intellectual property accounting management processing.

Note that the term “computer system” may include an OS, hardware such as peripheral equipment, and so forth.

Also, “computer system” includes a Web site providing environment (or display environment), in the event of employing a WWW system.

Also, “computer-readable recording medium” means a portable medium such as a flexible disk, an opto-magneto disk, ROM, CD-ROM, and so forth, or a storage device such as a hard disk built into a computer system.

Further, “computer-readable recording medium” includes a medium which retains the program for a given length of time, such as volatile memory (RAM) within a computer system serving as a server or client in the event that the program is transmitted via a network such as the Internet, or a communication line such as a phone line.

Also, the above program may be transmitted from a computer system which stores this program in a storage device or the like to another computer system via a transmission medium, or a carrier wave within a transmission medium. Here, “transmission medium” which transmits the program means a medium including a function for transmitting information, such as a network (communication network) such as the Internet, or a communication line (line) such as a phone line.

Also, the above program may be a program for realizing part of the above functions. Further, the above program may be a so-called difference file (difference program), which can realize the above function by a combination with a program already recorded in the computer system.

Description has been made regarding the embodiments of the present invention with reference to the drawings, but a specific configuration is not restricted to these embodiments, and encompasses design modifications thereof without departing from the spirit and scope of the present invention.

1. An intellectual-property accounting management device comprising:
an acquisition price storage unit for storing an acquisition price for each intellectual property;
an acquisition expense input unit for inputting an amount of an acquisition expense expended for acquiring a particular intellectual property; and
an intellectual-property accounting management unit for updating the acquisition price stored in said acquisition price storage unit based on said input acquisition expense, and performing intellectual property accounting processing.

2. An intellectual-property accounting management device according to claim 1, further comprising an expense storage unit for storing an acquisition expense for each intellectual property for each fiscal year;
wherein said intellectual-property accounting management unit comprises:
an expense updating unit for adding said input acquisition expense to the acquisition expense of the relevant fiscal year of the relevant intellectual property stored in said expense storage unit; and
an expense aggregation unit for aggregating the acquisition expense stored in said expense storage unit for each intellectual property, and storing each aggregated result in said acquisition price storage unit as the acquisition price of each relevant intellectual property.

3. An intellectual-property accounting management device according to claim 2, wherein said expense storage unit, which stores the contents of said acquisition expense for each expense item, comprises:
a selected-item storage unit for storing items to be included in the acquisition price of an intellectual property, of said expense items; and
a selection unit for selecting expenses to be included in the acquisition price of an intellectual property in accordance with the setting contents of said selected-item storage unit.

4. An intellectual-property accounting management device according to claim 3, wherein said expense items include at least two or more of: a refund fee to be paid to a creator of an intellectual property, research & development expenses, an attorney's fee to be paid to an attorney to which procedures according to an intellectual property are left, and a payment fee according to an intellectual property.

5. An intellectual-property accounting management device according to claim 4, further comprising:
a technical-field storage unit for storing a technical field for each intellectual property; and
a research & development expenses allocation unit for allocating research & development expenses to be input for each technical field to each intellectual property belonging to the relevant technical field, and reflecting the allocation results in said expense storage unit.

6. An intellectual-property accounting management device according to claim 5, wherein said research & development expenses allocation unit equally divides the research & development expenses of the relevant technical field for the worth of the number of intellectual properties belonging to the same technical field.

7. An intellectual-property accounting management device according to claim 5, further comprising:
a weighting coefficient storage unit for storing a weighting coefficient for each intellectual property;
wherein said research & development expenses allocation unit allocates the research & development expenses of the relevant technical field according to the ratio of the weighting coefficients possessed by the intellectual properties belonging to the same technical field.

8. An intellectual-property accounting management device according to claim 5, further comprising:
a deferred-assets storage unit for storing, as deferred assets, the research & development expenses regarding an allocatable intellectual property not acquired;
wherein said research & development expenses allocation unit starts allocation of the relevant research & development expenses, in the event that the intellectual property based on the research & development expenses which have become said deferred assets occurs.

9. An intellectual-property accounting management device according to claim 1, wherein said intellectual-property accounting management unit comprises:
a fixed-assets decision unit for determining whether or not said acquisition price is equal to or greater than a predetermined amount to be earmarked as fixed assets, and outputting fixed assets information.

10. An intellectual-property accounting management device according to claim 9, further comprising:
a fixed-assets storage unit for storing an acquisition price for each intellectual property to be served as fixed assets;
wherein said fixed-assets decision unit stores the acquisition price equal to or greater than said predetermined amount in said fixed-assets storage unit.

11. An intellectual-property accounting management device according to claim 1, further comprising:
a depreciation period storage unit for storing a depreciation period for each intellectual property;
wherein said intellectual-property accounting management unit comprises:
a depreciation expense calculation unit for calculating depreciation and undepreciated balance for each intellectual property based on the acquisition price stored in said acquisition price storage unit and the depreciation period stored in said depreciation period storage unit.

12. An intellectual-property accounting management device according to claim 11, further comprising:
a depreciation expense storage unit for storing said newest depreciation calculated for each intellectual property for each fiscal year; and
a previous depreciation expense storage unit for storing the depreciation previously calculated for each intellectual property for each fiscal year;
wherein said intellectual-property accounting management unit comprises:
a depreciation expense differential amount calculation unit for calculating the differential amount between the depreciation stored in said depreciation expense storage unit and the depreciation stored in said previous depreciation expense storage unit for each fiscal year; and
a depreciation expense total differential amount calculation unit for aggregating the differential amount between the depreciation expenses of all the intellectual properties for each fiscal year based on said calculated differential amount of the depreciation.

13. An intellectual-property accounting management device according to claim 11, further comprising:
a depreciation period calculation information input unit for inputting an acquisition year and expiration year of a particular intellectual property;
wherein said intellectual-property accounting management unit comprises a depreciation period calculation unit for calculating the depreciation period of the relevant intellectual property based on said acquisition year and expiration year, which were input.

14. An intellectual-property accounting management device comprising:
an acquisition expense input unit for inputting an amount of an acquisition expense expended for acquiring a particular intellectual property;
an expense storage unit for storing an acquisition expense for each intellectual property for each fiscal year;
an expense updating unit for adding said input acquisition expense to the acquisition expense of the relevant fiscal year of the relevant intellectual property stored in said expense storage unit;
an expiration year storage unit for storing an expiration year for each intellectual property;
a book price storage unit for storing a book price for each intellectual property;
a previous-year depreciation expense calculation unit for calculating a depreciation period from the previous year of a particular year based on the expiration year stored in said expiration year storage unit, and calculating a depreciation expense of said particular year based on said depreciation period and the book price of the previous year stored in said book price storage unit; and
a book price updating unit for subtracting said calculated depreciation expense of the previous year from the book price of the previous year, adding the acquisition expense of the previous year stored in said expense storage unit to this subtracted result, and storing the added result in said book price storage unit as said book price of the particular year.

15. An intellectual-property accounting management device according to claim 14, wherein said expense storage unit, which stores the contents of said acquisition expense for each expense item, comprises:
a selected-item storage unit for storing items to be included in the book price of an intellectual property, of said expense items; and
a selection unit for selecting expenses to be included in the book price of an intellectual property in accordance with the setting contents of said selected-item storage unit.

16. An intellectual-property accounting management device according to claim 15, wherein said expense items include at least two or more of: a refund fee to be paid to a creator of an intellectual property, research & development expenses, an attorney's fee to be paid to an attorney to which procedures according to an intellectual property are left, and a payment fee according to an intellectual property.

17. An intellectual-property accounting management device according to claim 16, further comprising:
a technical-field storage unit for storing a technical field for each intellectual property; and
a research & development expenses allocation unit for allocating research & development expenses to be input for each technical field to each intellectual property belonged to the relevant technical field, and reflecting these allocation results in said expense storage unit.

18. An intellectual-property accounting management device according to claim 17, wherein said research & development expenses allocation unit equally divides the research & development expenses of the relevant technical field for the worth of the number of intellectual properties belonging to the same technical field.

19. An intellectual-property accounting management device according to claim 17, further comprising:
a weighting coefficient storage unit for storing a weighting coefficient for each intellectual property;
wherein said research & development expenses allocation unit allocates the research & development expenses of the relevant technical field according to the ratio of the weighting coefficients possessed by the intellectual properties belonging to the same technical field.

20. An intellectual-property accounting management device according to claim 17, further comprising:
a deferred-assets storage unit for storing, as deferred assets, the research & development expenses regarding an allocatable intellectual property not acquired;
wherein said research & development expenses allocation unit starts allocation of the relevant research & development expenses, in the event that the intellectual property based on the research & development expenses which have become said deferred assets occurs.

21. An intellectual-property accounting management device according to claim 14, further comprising:
a fixed-assets decision unit for determining whether or not said book price is equal to or greater than a predetermined amount to be earmarked as fixed assets, and outputting fixed assets information.

22. An intellectual-property accounting management device according to claim 21, further comprising:
a fixed-assets storage unit for storing a book price for each intellectual property to serve as fixed assets;
wherein said fixed-assets decision unit stores said book price equal to or greater than a predetermined amount in said fixed-assets storage unit.

23. An intellectual-property accounting management device according to claim 13, wherein said acquisition year is the year when the relevant intellectual property was filed.

24. An intellectual-property accounting management device according to claim 13, wherein said acquisition year is the year when the relevant intellectual property was subjected to registration of rights.

25. An intellectual-property accounting management device according to claim 13, wherein said expiration year is calculated based on a shorter period, of a duration of rights determined by industrial property law, or a period determined by tax law.

26. An intellectual-property accounting management device according to claim 13, wherein said expiration year is calculated based on the shortest period, of a duration of rights determined by industrial property law, or the period determined by tax law, or the technical remaining life of the relevant intellectual property.

27. An intellectual-property accounting management program for performing intellectual property accounting processing in an intellectual-property accounting management device comprising a processing unit for performing various types of intellectual property accounting processing, and various types of storage units for storing various types of data to be used for intellectual property accounting management, said program causing a computer to execute:
processing for inputting an amount of an acquisition expense expended for acquiring a particular intellectual property;
acquisition price updating processing for updating an acquisition price stored in an acquisition price storage unit for storing the acquisition price for each intellectual property based on said input acquisition expense; and
accounting management processing for performing intellectual property accounting processing based on the updated acquisition price.

28. An intellectual-property accounting management program according to claim 27, wherein said acquisition price updating unit includes:
processing for adding said input acquisition expense to the acquisition expense of the relevant fiscal year of the relevant intellectual property stored in an expense storage unit for storing the acquisition expense for each intellectual property for each fiscal year;
processing for aggregating the acquisition expense stored in said expense storage unit for each intellectual property; and
processing for storing each aggregated result in said acquisition price storage unit as the acquisition price of each relevant intellectual property.

29. An intellectual-property accounting management program according to claim 28, wherein said expense storage unit stores the contents of said acquisition expense for each expense item;
and wherein said intellectual-property accounting management device comprises a selected-item storage unit for storing items to be included in the acquisition price of an intellectual property, of said expense items;
and wherein a computer is further caused to execute processing for selecting expenses to be included in the acquisition price of an intellectual property in accordance with the setting contents of said selected-item storage unit.

30. An intellectual-property accounting management program according to claim 29, wherein said expense items include at least two or more of: a refund fee to be paid to a creator of an intellectual property, research & development expenses, an attorney's fee to be paid to an attorney to which procedures according to an intellectual property are left, and a payment fee according to an intellectual property.

31. An intellectual-property accounting management program according to claim 30, wherein said intellectual-property accounting management device comprises a technical-field storage unit for storing a technical field for each intellectual property;
and wherein a computer is further caused to execute research & development expenses allocation processing for allocating research & development expenses to be input for each technical field to each intellectual property belonging to the relevant technical field, and reflecting the allocation results in said expense storage unit.

32. An intellectual-property accounting management program according to claim 31, wherein with said research & development expenses allocation processing, the research & development expenses of the relevant technical field for the worth of the number of intellectual properties belonging to the same technical field are divided equally.

33. An intellectual-property accounting management program according to claim 31, wherein said intellectual-property accounting management device comprises a weighting coefficient storage unit for storing a weighting coefficient for each intellectual property;
and wherein with said research & development expenses allocation processing, the research & development expenses of the relevant technical field according to the ratio of the weighting coefficients possessed by the intellectual properties belonging to the same technical field are allocated.

34. An intellectual-property accounting management program according to claim 31, wherein said intellectual-property accounting management device comprises a deferred-assets storage unit for storing, as deferred assets, the research & development expenses regarding an allocatable intellectual property not acquired;
and wherein with said research & development expenses allocation processing, allocation of the relevant research & development expenses is started, in the event that the intellectual property based on the research & development expenses which have become said deferred assets occurs.

35. An intellectual-property accounting management program according to claim 27, wherein said accounting management processing includes processing for determining whether or not said acquisition price is equal to or greater than a predetermined amount to be earmarked as fixed assets, and outputting fixed assets information.

36. An intellectual-property accounting management program according to claim 35, wherein said accounting management processing includes processing for storing said acquisition price equal to or greater than a predetermined amount in a fixed-assets storage unit for storing an acquisition price for each intellectual property to be served as fixed assets.

37. An intellectual-property accounting management program according to claim 27, wherein said accounting management processing includes processing for calculating depreciation and undepreciated balance for each intellectual property based on the acquisition price stored in said acquisition price storage unit and the depreciation period stored in a depreciation period storage unit for storing a depreciation period for each intellectual property.

38. An intellectual-property accounting management program according to claim 37, wherein said accounting management processing includes:
processing for calculating the differential amount between the depreciation stored in a depreciation expense storage unit for storing said newest depreciation calculated for each intellectual property for each fiscal year, and the depreciation stored in a previous depreciation expense storage unit for storing said previous depreciation calculated for each intellectual property for each fiscal year; and
processing for aggregating the differential amount of the depreciation of all intellectual properties for each fiscal year based on said calculated differential amount of the depreciation.

39. An intellectual-property accounting management program according to claim 37, further causing a computer to execute processing for inputting the acquisition year and expiration year of a particular intellectual property, wherein said accounting management processing includes processing for calculating the depreciation period of the relevant intellectual property based on said acquisition year and expiration year which were input.

40. An intellectual-property accounting management program for performing intellectual property accounting management processing in an intellectual-property accounting management device comprising a processing unit for performing various types of intellectual property accounting processing, and various types of storage units for storing various types of data to be used for intellectual property accounting management, and said program causing a computer to execute:
processing for inputting an amount of an acquisition expense expended for acquiring a particular intellectual property;
processing for adding said input acquisition expense to the acquisition expense of the relevant fiscal year of the relevant intellectual property stored in an expense storage unit for storing the acquisition expense for each intellectual property for each fiscal year;
processing for calculating a depreciation period from the previous year of a particular year based on an expiration year stored in an expiration year storage unit for storing the expiration year for each intellectual property;
processing for calculating a depreciation expense of the previous year based on said calculated depreciation period, and a book price of the previous year stored in a book price storage unit for storing the book price for each intellectual property; and
processing for subtracting said calculated depreciation expense of the previous year from said book price of the previous year, adding said acquisition expense of the particular year stored in said expense storage unit to the subtracted result, and storing the added result in said book price storage unit as said book price of the particular year.

41. An intellectual-property accounting management program according to claim 40, wherein said expense storage unit stores the contents of said acquisition expense for each expense item;
and wherein said intellectual-property accounting management device comprises a selected-item storage unit for storing items to be included in the book price of an intellectual property, of said expense items;
and wherein a computer is further caused to execute processing for selecting expenses to be included in the book price of an intellectual property in accordance with the setting contents of said selected-item storage unit.

42. An intellectual-property accounting management program according to claim 41, wherein said expense items include at least two or more of: a refund fee to be paid to a creator of an intellectual property, research & development expenses, an attorney's fee to be paid to an attorney to which procedures according to an intellectual property are left, and a payment fee according to an intellectual property.

43. An intellectual-property accounting management program according to claim 42, wherein said intellectual-property accounting management device comprises a technical-field storage unit for storing a technical field for each intellectual property;
and wherein a computer is further caused to execute research & development expenses allocation processing for allocating research & development expenses to be input for each technical field to each intellectual property belonged to the relevant technical field, and reflecting the allocation results in said expense storage unit.

44. An intellectual-property accounting management program according to claim 43, wherein with said research & development expenses allocation processing, the research & development expenses of the relevant technical field for the worth of the number of intellectual properties belonging to the same technical field are divided equally.

45. An intellectual-property accounting management program according to claim 43, wherein said intellectual-property accounting management device comprises a weighting coefficient storage unit for storing a weighting coefficient for each intellectual property;
and wherein with said research & development expenses allocation processing, the research & development expenses of the relevant technical field are allocated according to the ratio of the weighting coefficients possessed by the intellectual properties belonging to the same technical field.

46. An intellectual-property accounting management program according to claim 43, wherein said intellectual-property accounting management device comprises a deferred-assets storage unit for storing, as deferred assets, the research & development expenses regarding an allocatable intellectual property not acquired;
wherein with said research & development expenses allocation processing, allocation of the relevant research & development expenses is started, in the event that the intellectual property based on the research & development expenses which have become said deferred assets occurs.

47. An intellectual-property accounting management program according to claim 40, wherein a computer is further caused to execute processing for determining whether or not said book price is equal to or greater than a predetermined amount to be earmarked as fixed assets, and outputting fixed assets information.

48. An intellectual-property accounting management program according to claim 47, wherein a computer is further caused to execute processing for storing said book price equal to or greater than a predetermined amount in a fixed-assets storage unit for storing a book price for each intellectual property to be served as fixed assets.

49. An intellectual-property accounting management device according to claim 14, wherein said expiration year is calculated based on a shorter period, of a duration of rights determined by industrial property law, or a period determined by tax law.

50. An intellectual-property accounting management device according to claim 14, wherein said expiration year is calculated based on the shortest period, of a duration of rights determined by industrial property law, or the period determined by tax law, or the technical remaining life of the relevant intellectual property.
